(19) United States
(12) Patent Application Publication
(10) Pub. No.: US 2005/0257719 A1
(43) Pub. Date: Nov. 24, 2005

(54) Disposal of hazardous cathode ray tube waste, using a biopolymer modified concrete system

(76) Inventors: Daeik Kim, Anaheim, CA (US); Teh Fu Yen, Altadena, CA (US)

Correspondence Address: FISH & RICHARDSON, PC, 12390 EL CAMINO REAL, SAN DIEGO, CA, 92130-2081, US

(21) Appl. No.: 11/117,070

(22) Filed: Apr. 27, 2005

Related U.S. Application Data
(60) Provisional application No. 60/565,887, filed on Apr. 27, 2004.

(51) Int. Cl. C03B 23/20; C04B 7/00

(52) U.S. Cl. 106/638; 106/676

(57) ABSTRACT

A structural material formed of concrete-like substances which includes lead-including sand embedded within the structural material. One aspect bind the lead-containing sand using the biopolymer and/or a cross-linking agent. The biopolymers can be Xanthan gum, guar gum, and/or Chitosan. Different materials can be used for the cross-linking agent including boric acid. The materials cause the lead to be bound within a matrix within the structure, and prevent the lead from leaching out.

### CROSS-REFERENCE TO RELATED APPLICATIONS

This application claims priority to U.S. Application Ser. No. 60/,565,887 filed on Apr. 27, 2004.

### STATEMENT OF GOVERNMENT INTEREST

The present application received funding from the Department of Energy, national energy technology laboratory, grant number DE-AC26-01NT41307. The government may have certain rights in this invention.

### BACKGROUND

Computer monitors, televisions, camcorders, and other electronic display devices often use a display formed of a cathode ray tube or CRT. These devices convert an electronic signal into a visual image that can be viewed. Up until a decade ago, CRTs were the display of choice. New technologies, including liquid crystal, plasma, DMD based technologies and others have enabled lower power, higher brightness, and lower weight displays. Therefore, many such CRT displays have been discarded and end up in the landfill.

Unfortunately, cathode ray tubes often contain 20% lead oxide by weight, which means that there is 5 to 8 pounds of lead in some units. A typical 17 inch computer monitor contains approximately 2.2 pounds of lead. A 27 inch television contains up to 8 pounds of lead. Since these devices exceed the regulatory threshold for lead content, they may be identified as hazardous materials when discarded.

The dangers of lead in landfills is well-known. The lead can contaminate soil and water supplies. Therefore, disposal of CRTs in the trash is typically prohibited.

Approximately 2.9 million TVs or 74,000 tons; and 3.2 million computer monitors; 48,000 tons of computer monitors, are stockpiled in California households. The 2003 estimate for stockpiled computers is around 0.7 million tons of lead just in North America. Electronic waste such as television sets, personal computers, radios and VCRs forms the number 4 source of lead in municipal solid waste rankings.

Also importantly, lead is a cumulative poison. Elevated levels of lead leads to lead poisoning which may adversely affect mental development and performance, kidney function, gastrointestinal operation, the hematopoietic system which includes blood forming tissues, cardiovascular system, the central and peripheral nervous systems, the immune system, and the reproductive system. Elevated lead levels can also impair proper sperm function since lead exposure can contribute to a reduction in sperm count, sperm shape, form and movement. Substantial amounts of lead may interfere with the ability of the sperm to penetrate the ova, and the ova's capability for fertilization.

### SUMMARY

This application describes a method of forming a structural material based on hazardous CRT glass. The CRT glass may have lead components in specified amounts. It also describes the actual concrete like materials formed using CRT glass in place of some of the sand that is usually a part of the concrete materials. The concrete materials trap and hence dispose of hazardous material of this type, e.g., from CRTS. This technology forms marketable and recyclable products as well as minimizing the hazardous wastes component. This technology uses commercially available biopolymers to bind lead from the CRT “glass” into a material which can be used for building materials.

The materials preferably have mechanical properties which may allow them to be used in place of ordinary concrete materials. These building materials also have a low leachability for the encapsulated lead.

An aspect of the present system describes using biopolymers to encapsulate lead from CRT wastes.

### BRIEF DESCRIPTION OF THE DRAWINGS

These and other aspects will now be described in detail with reference to the accompanying drawings, wherein:

FIGS. 1A-1C respectively show the structure of the biopolymers that can be used in different embodiments;

FIG. 2 shows the way in which lead is postulated to be stabilized using xanthan gum;

FIG. 3 illustrates the cross-linking reaction between guar gum and borate ions;

FIG. 4 shows the interaction between Xanthan and guar forming the simulated cross-linking;

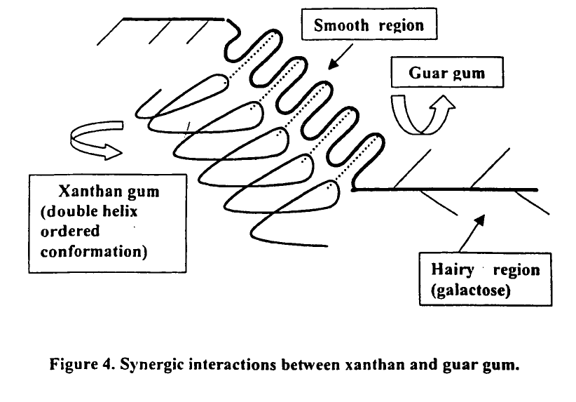

FIGS. 5A and 5B show different compression strengths of different compositions of the different embodiments;

FIG. 6 illustrates the cross-linking in the CBC composite.

### DETAILED DESCRIPTION

Biopolymers are typically high molecular weight compounds that have repeating sequences of functional groups. These simple functional groups may become multiple reactive sites which provide opportunities for physical and chemical reactions to take place. Reactions of this type can cause a cross-linking capacity. One aspect of the present application uses materials which have characteristics of metal chelation, such as Xanthan gum, Guar gum, and chitosan. This allows the metals to form complexes with the functional groups of organic compounds. For example, Xanthan gum includes the presence of particular functional groups such as CH₂OH, OH, COOH and OH in its structure. These functional groups allow the Xanthan gum to bind metals, sand and cement articles by creating stable interpenetrating cross-linking networks. In addition, cross-linking agents may be added. An exemplary cross-linking agent is boric acid that produces borate ions applied to a biopolymer reaction. The cross-linking reaction between the biopolymer and the cross-linking agent occurs, and eventually builds a three-dimensional model between the target metal, the lead, and the concrete structure. The biopolymer may also function as the adhesive in what is predominantly a calcium carbonate matrix, thereby effectively gluing the lead on to the concrete molecules which contain large amounts of calcium carbonate in the form of concrete composite.

If the present system forms a material which is referred to herein as CRT-biopolymer-concrete, or CBC composite. Different CBC compounds are described as embodiments of the present application. The properties of those materials are also described, typically the properties after curing for 47 days.

In an embodiment, mixing is performed in the sequence: cement-sand-water-cement-sand-CRT-water-biopolymer solution and/or cross-linked solution.

A number of different compounds are described herein. Each compound forms an embodiment. Each different compound is numbered and its components and characteristics are described in table 3.

For example, CBC 1 is formed by mixing 550 g of cement to 1000 g of sand to 147 g of water and forming a paste. A second paste 500 g of cement, 900 g of sand, 350 g of CRT material, 200 g of water, and 70 g of Xanthan gum is formed by adding these materials to the first paste. CRT materials and the other ingredients are thoroughly mixed to ensure that the lead from the CRT are distributed into the microstructure of the concrete system, and encapsulated by the biopolymer or cross-linked solution.

The Xanthan gum solution was prepared in deionized water of act concentrations of 0.1% (1000 mg per liter) and 0.5% (5000 mg per liter. This used Xanthan gum powder manufactured by CPKelco (Kelzant).

Alternatively, Guar gum purchased from gum technology may be used; coyote brand Guar, High viscosity. The Guar material is prepared in deionized water at a concentration of 0.1% and 0.5%.

Another embodiment uses chitosan, obtained from Makecare Inc., prepared in the same concentrations as the above. Chitosan is insoluble in water and hence is dissolved in 1% acetic acid.

Boric acid may be used as a cross-linking agent, prepared in deionized water at concentrations of 0.1% and 0.5%.

A guar and boric cross-linked solution; and a guar and Xanthan gum cross-linked solution is formed by mixing the gum at 0.1% with 0.1% boric acid at a volume ratio of 4:1. The example uses industrial sand manufactured by Accosand, Inc (Ottawa sand) and cement I-II type manufactured by California Portland Cement Co., Colton California.

Table 1 shows the characteristics of the different biopolymers that can be used in the embodiments.

TABLE 1
Source, structure, property, and application of biopolymers (xanthan gum, guar gum, and chitosan)

| | Source | Structure | Property |
|---|---|---|---|
| Xanthan gum | produccd by Xanthomonas | five sugar residues: two glucose, two | high viscosity at even low concenttation, high |
| (extracellular | campestris that is a genus of | mannose, and one glucuronic acid, in | viscosity at low shear rates, high degree of |
| biopolymer) | the Pseudomonaceae | the molar ratio 2.8:2.0:2.0 (17) | pseudoplasticity. |
| | family | molecular weight: from 2 × 10⁶ to | high elastic modulus (19) |
| | | 20 × 10⁶ Daltons (2.000 up to 20,000 | compatibility with ionic strength variation, |
| | | repeating units) | heat, pH, shear, enzymes, chemicals |
| | | functional groups: | |
| | | CH₂OH, OH, O, COOH, H. | |
| Guar gum | extracted from the seed of | 1→4-linked β-D-mannopyranose | economical thickener and stabolizer |
| (plant biopolymer) | Guar Gum Plant, the | backbone with branchpoints from their | viscous pseudoplastic, high low-shear |
| | leguminous shrub Cyamopsis | 6-positions linked to α-D-galactose (i.e. | viscosity, shear thinning, less affected by ionic |
| | tetraganoloba | 1→6-linked-α-D-galactopyranose). | strength or pH, synergic effect with xanthan |
| | | Every galactose residue exists between | gum |
| | | 1.5-2 mannose residues. (13) | |
| | | molecular weight: 2 × 10⁶ Daltons (up | |
| | | to 10,000 repeating units) | |
| | | functional groups: | |
| | | CH₂OH, OH, O, H. | |
| Chitosan | a derivative of chitin, found | 2-acetamido-2-deoxy-β-D-glucose | Insoluble material, only soluble in dilute acids |
| (structural | in supporting materials of | (N-acetylglucosamine) through a | biocompatibility, biodegrability, non-toxicity, |
| biopolymer) | crustaceans | β(1→4)-linkage(18) | polyoxysalt formation, film-forming ability, |
| | (crabs, lobsters, shrimp, | molecular weight: 1 × 10⁵ to | optical characteristics, adsorption property |
| | insects, worms, fungi) | 5 × 10⁵ Daltons. | |
| | | functional groups: | |
| | | CH₂OH, O, OH, NH₂ | |

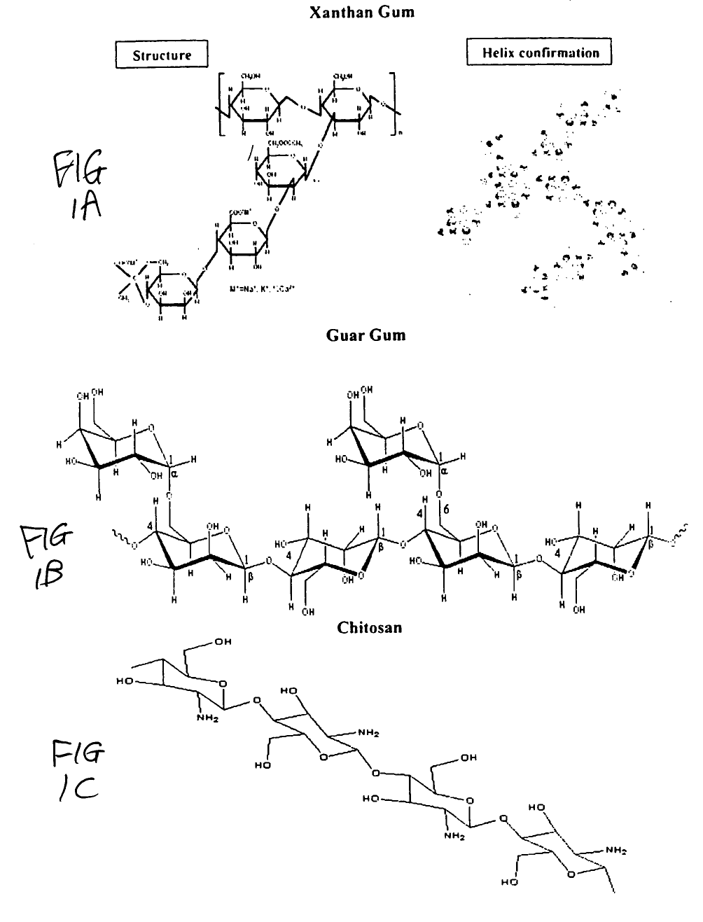

Xanthan gum has the general structure of a helix as shown in FIG. 1a. Guar gum has the general structure shown in FIG. 1b, and Chitosan has the general structure shown in FIG. 1c.

The waste material from the CRT, also referred to herein as “CRT sand”, may be prepared as follows. A CRT structure is formed of the cathode Ray tube itself, the casing formed of a plastic shell, metals, connecting wiring, circuits and/or integrated circuits, shielding, rubber, and a deflection yoke. The tube itself ranges in weight between eight and 70 pounds depending on the size and manufacturer.

Preparation of the samples involve dismantling the monitors into the plastic shell, their inner electrical parts, and the CRT glass. The CRT glass is itself separated into panel, funnel, and neck glass. Each of these are crushed, ground and mixed together to form a homogeneous lead concentration. It is noted, however, that the lead is mostly confined to the funnel and neck parts of the CRT glass. One aspect may separate the different parts to form separate building materials with different lead concentrations.

In the actual sample, the total concentration of lead in the mixed sample, called coarse CRT glass, was about 5883 mg per liter. Table 2 shows the elemental analysis of this glass, as well as showing the lead at concentrations in the different parts of the funnel and neck.

TABLE 2
ICP-MS elemental analysis of CRT glass (coarse size)

| | Concentration | | Concentration |
|---|---|---|---|
| Element | (mg/L) | Element | (mg/L) |
| Be | << | Cu | 3.926 |
| Na | 437.6 | Zn | 568.500 |
| Mg | 6.667 | As | 0.2546 |
| Al | 91.93 | Se | 1.368 |
| K | 440.30 | Sr | 100.100 |
| Ca | 194.40 | Mo | << |
| Ti | 1.79 | Ag | << |
| V | << | Cd | << |
| Cr | 1.23 | Sn | 0.4959 |
| Fe | 21.16 | Sb | 8.602 |
| Mn | 5.282 | Ba | 270.80 |
| Fe | 19.38 | Tl | 0.1325 |
| Co | << | Pb | 5883 |
| Ni | << | | |

TCLP results of fine and coarse samples in different
parts of CRT unit

| | | Coarse sample | Fine sample |
|---|---|---|---|
| | Sample # | (mg/L) | (mg/L) |
| Mixed sample | 1 | 307.3 | 782 |
| | 4 | 78.95 | 13.29 |
| | 5 | 43.70 | 64.92 |
| Panel | 3 | 6.86 | 6.55 |
| Funnel | 3 | 77.67 | 162.92 |
| Neck | 3 | 12.44 | 53.59 |
| Funnel | 25* | 149.2 | 198.2 |
| Funnel | 26* | 209.8 | 439.7 |
| Funnel | 35* | 44.7 | 171.5 |

<< below detection limit
*Samples are from Handy and Harman Electronic Materials Corp. 2002 (8).

The crushed CRT glass is then sieved into different fractions to form fine and coarse CRT glasses. The fine samples may be less than number 140 mesh (less than 0.105 mm). Coarse CRT glass are between 100 to 40 mesh (0.149-0.42 mm). The fine CRT glass would be expected to have a much higher lead content, since it has a greater glass particle surface area.

The CRT glass is used to form CBC compositions. Embodiments 1-10 are illustrated in Table 3 which shows the different CBC combinations, and illustrates the compressive strength and leachability of these combinations.

TABLE 3
CBC compositions using biopolymer solutions and results of compressive strength and leachability

| | | CBC 1 | CBC 2 | CBC 3 | CBC 4 | CBC 5 | CBC 6 | CBC 7 | CBC 8 | CBC 9 | CBC 10 |
|---|---|---|---|---|---|---|---|---|---|---|---|
| | | Xanthan | Xanthan | Xanthan | Xanthan | Guar | Guar | Guar | Chitosan | Chitosan | Chitosan |
| | Ordinary | 0.1% | 0.5% | 0.1% | 0.5% | 0.1% | 0.5% | 0.1% | 0.1% | 0.5% | 0.1% |
| | Concrete | (70 g) | (70 g) | (417 g) | (417 g) | (70 g) | (70 g) | (417 g) | (70 g) | (70 g) | (417 g) |
| Water* | 417/ | 347/ | 347/ | — | — | 347/ | 347/ | — | 347/ | 347/ | — |
| | 11.22 | 9.34 | 9.34 | | | 9.34 | 9.34 | | 9.34 | 9.34 | |
| Cement* | 1050/ | 1050/ | 1050/ | 1050/ | 1050/ | 1050/ | 1050/ | 1050/ | 1050/ | 1050/ | 1050/ |
| | 28.25 | 28.25 | 28.25 | 28.25 | 28.25 | 28.25 | 28.25 | 28.25 | 28.25 | 28.25 | 28.25 |
| Sand* | 2250/ | 1900/ | 1900/ | 1900/ | 1900/ | 1900/ | 1900/ | 1900/ | 1900/ | 1900/ | 1900/ |
| | 60.53 | 51.12 | 51.12 | 51.12 | 51.12 | 51.12 | 51.12 | 51.12 | 51.12 | 51.12 | 51.12 |
| CRT glass* | — | 350/ | 350/ | 350/ | 350/ | 350/ | 350/ | 350/ | 350/ | 350/ | 350/ |
| | | 9.42 | 9.42 | 9.42 | 9.42 | 9.42 | 9.42 | 9.42 | 9.42 | 9.42 | 9.42 |
| Biopolymer | — | 70/ | 70/ | 417/ | 417/ | 70/ | 70/ | 417/ | 70/ | 70/ | 417/ |
| solution* | | 1.88 | 1.88 | 11.22 | 11.22 | 1.88 | 1.88 | 11.22 | 1.88 | 1.88 | 11.22 |
| TCLP | — | 0.0972 | 0.003 | 0.1435 | 0.0475 | 0.283 | 0.247 | N/D | 0.152 | 0.097 | N/D |
| (mg/L) | | | | | | | | | | | |
| Compressive | 4135 | 4938 | 4673 | 4133 | 3242 | 5452 | 4772 | 3470 | 5213 | 5339 | 3688 |
| strength | | | | | | | | | | | |
| (psi) | | | | | | | | | | | |

Trapped air was less than 0.1% by weight
N/D: Non-detectable
*weight (g)/(%)

CBCs numbers 1-4 have a low 5 mg per liter as the lead leaching, and thereby have improved characteristics. CBC 3, on the other hand, and CBC 4, have weaker compression strength than ordinary concrete. Both CBC 1 and CBC 2 show approximately 20% and 13% higher compressive strength and concrete, respectively.

It is believed that a certain portion of the compressive strength relies on the amount of free water. Many investigators have suggested that complete concrete hydration can not occur if the water to concrete ratio is below approximately 0.38. However, different techniques may be used in place of hydration in a paste with as low as a 0.22 water to concrete ratio.

FIG. 1a illustrates the rigid helical configuration of Xanthan gum. As a result of this rigid helical configuration, the viscosity of Xanthan gum is relatively insensitive to differences in ionic strength and pH. This controls the low leaching of lead in the CBC. The protection of the backbone by the side chains provide superior stability to the Xanthan gum as compared with other polysaccharides, against acids, alkalis and enzymes.

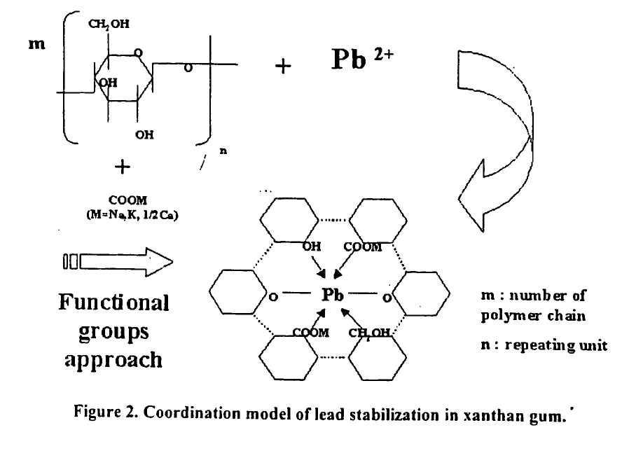

Xanthan gum is a giant high molecular weight compound between 2×10⁶ and 2×10⁷ in repeated sequences. Simple functional groups become the multiple reactive sites, and provide ample opportunities for chemical and physical reactions to take place. These reactions cause the cross-linking. The specific functional groups noted above react in the presence of a monomer. Xanthan gum is thus able to bind metals by structuring a coordination model which can encapsulate the lead in all binding connections from surrounded functional groups. FIG. 2 shows the basic Xanthan gum structure, plus the monomer, plus the lead, and shows how the functional groups stabilize the lead. Eventually, this coordination model attaches on to the sand, CRT sand and cement particles, by creating stable interpenetrating cross-linking networks. The metals can form complexes with the functional groups of organic compounds. If there is more than one functional group, then those functional groups can also chelate with metals.

For example, lead has a high affinity for oxygen, sulfur and nitrogen in the chelating process. This allows lead to easily click with lone pair in oxygen in the biopolymer. It appears that the biopolymer, Xanthan gum, containing lead, is quite resistance to microbial attack. It was observed that the Xanthan gum was minimally deteriorated by microorganisms, after complex. This indicated that the complex between lead in the biopolymer has become stabilized.

In addition, polymer functions as the adhesive in what becomes a predominantly calcium carbonate matrix. This allows the Xanthan gum to also glue onto the cement particles in the CBC.

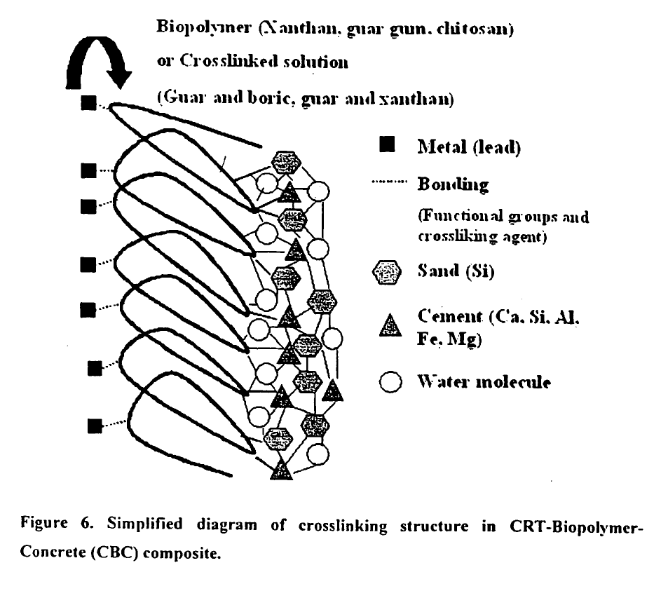

FIG. 6 illustrates a simplified diagram of a cross-linking structure in a CRT-biopolymer-concrete compounds. FIG. 6 shows the biopolymer being introduced to bind the lead on one side of itself in a coordination structure. The biopolymer has sand or cement particles attached to the other side, thereby creating a cross-linked composite.

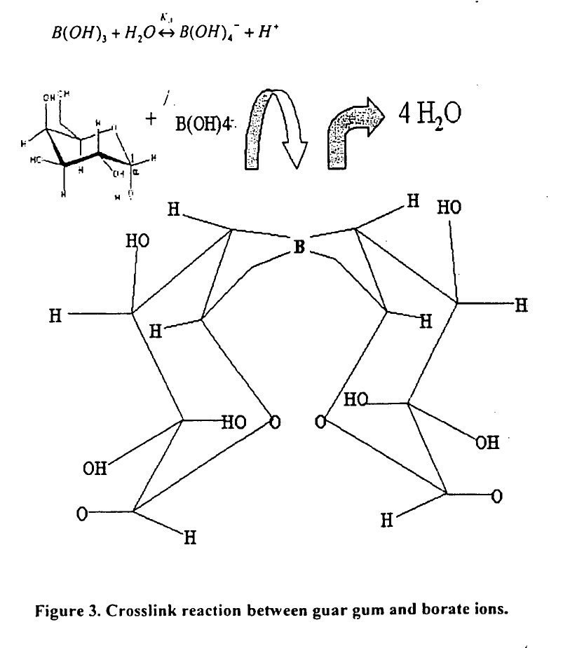

CBC 5, (also shown in table 3) shows a composite mix of guar gum and the test results are also shown in FIG. 3. Samples which were blended with guar gum were very dark in color, which is unlike the ordinary white concrete. This suggests that some reaction was observably initiated for the biopolymer composite. Compositions 5 and 6 showed sufficient strength for construction material; with composition 5 showing 32% higher strength than ordinary concrete, the highest compressive strength of all the samples. Each was below 5 mg per liter of lead leachability.

The encapsulation of the lead by the guar gum is believed to use a slightly different mechanism. Guar is a naturally occurring polysaccharide composed of a linear backbone of (1-4)-beta-linked the mannose units with (1-5) alpha-linked galactose units randomly attached as side chains. The side chains are “hairy” and the backbone chains are smooth. They include the functional groups CH₂OH, O and H, as well as many OH groups from Trans Hydroxyls (mannose) and cis-hydroxyls (galactose). Many OH groups may be available for cross-linked reaction with borate ion from boric acid. They form a strong chain interaction through the intermolecular an intra molecular junction zones similar to FIG. 2.

Also similar to FIG. 2, the different functional groups approach the lead to connect each other in a coordination structure. This coordination model ultimately attaches to the concrete and creates a three-dimensional interpenetrating cross-linked network similar to the Xanthan gum.

Composites with Chitosan are made the same way as the other polymers. CBCs 8-10 in table 3 show the results. CBCs 8 and 9 have high compressive strength, while 10 shows relatively low strength, likely because of the water shortage. Note that when using Xanthan and guar gum, there is a decreased strength with the increased concentration of biopolymer. This is believed to be because Xanthan and guar gum are both viscous materials that require water to maintain their hydrogel structure. In contrast, Chitosan does not show this kind of viscosity, even at a higher concentration.

From this, it is concluded that the viscosity of the biopolymer is probably not related to the strength of the CBC. However, the water ratio may be a significant factor.

The lead encapsulation by Chitosan is well described in the industry. Chitosan has a natural selectivity for metal heavy ions. It is believed that lead will be chelated with groups in the Chitosan chain, and that chitosan's amino sugar become the major effective binding site for the metal ions. This form stable complexes in coordination. Nitrogen electrons that are present in the amino and N-acetylamino groups can establish dative bonds and transition metal ions as well as other functional bonds like oxygen alcohol and some hydroxyl group in this biopolymer may function as donors. Hence, all of the binding groups in Chitosan can similarly stabilize lead in an encapsulation structure.

Embodiments 11-14 are illustrated in Table 4 which shows the relationship between different CBC compositions, and the results of their compressive strength and leachability.

TABLE 4
CBC compositions using crosslinked solutions and results of
compressive strength and leachabilily

| | CBC 11 | CBC 12 | CBC 13 | CBC 14 |
|---|---|---|---|---|
| | Guar & Boric | Guar & Boric | Xanthan & Guar | Xanthan & Guar |
| | solution 0.1% | solution 0.1% | solution 0.1% | solution 0.1% |
| | (70 g) | (417 g) | (70 g) | (417 g) |
| Water* | 347/9.34 | — | 347/9.34 | — |
| Cement* | 1050/28.25 | 1050/28.25 | 1050/28.25 | 1050/28.25 |
| Sand* | 1900/51.12 | 1900/51.12 | 1900/51.12 | 1900/51.12 |
| CRT glass* | 350/9.42 | 350/9.42 | 350/9.42 | 350/9.42 |
| Crosslinked | 70/1.88 | 417/11.22 | 70/1.88 | 417/11.22 |
| solution* | | | | |
| TCLP (mg/L) | N/D | 0.1480 | N/D | 0.2529 |
| Compressive | 5047 | 5018 | 5446 | 3068 |
| strength (psi) | | | | |

Trapped air was less than 0.1% by weight.
N/D: Non-detectable
*weight (g)/(%)

Compositions 11 and 12 show high compressive strengths. Composition 12 also shows a high compressive strength. This is believed to be caused by the property of guar gum having changed to a cross-linked structure with borate ions, and whereby the byproduct water from the reaction may be transferred to the cement microstructure. FIG. 3 illustrates the cross-linked reaction between the guar gum and the borate ions, forming free water for this reaction. This allows strong concrete with a low water to concrete ratio for these materials.

In these materials, there is a cross-linked reaction between guar gum and boric acid. Boric acid, which is B(OH)₃ which dissociates to a borate ion B(OH)₄⁻ which forms the effective species in cross-linking. The concentration is a function of the pH, temperature and concentration of boric acid in the solution.

Equation 1 illustrates the acid-base equilibrium which is established between boric acid and monoborate ions.

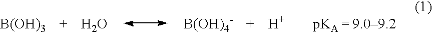

The monoborate of the ions react with the cis-hydroxyl of the groups in the guar to form cross-linked structures. Since the galactose and the mannose units are the repeating units in guar, similar reactions are expected to occur between the borate ion and the hydroxyl groups on the guar. This reaction favors a weak base, e.g. pH greater than 9, and does not like high temperature.

The viscosity of the cross-linked solution drastically increases over pH 9 and it is also noted that a small increase in viscosity is observed when increasing the concentration of the cross-linking agent from 0.1% to 0.5%. The cross-linking reaction in guar and boric is caused by pH manipulation. The pH value of the composite automatically pops up when mixing with cement paste having alkaline materials. This can be advantageous to maintain the CRT glass into the concrete, mixed with a cross-linked biopolymer solution.

It appears experimentally that temperature does not affect the cross-linking, and that operation and mixture at room temperature is effective to secure the cross links between the guar gum hydroxyl groups and boric acid borate ions.

Composites 13 and 14 use combinations of Xanthan and guar gum in a ratio of four to one. A crosslink reaction is caused by mixing of the two different polymers. While neither of these polymers are themselves cross-linking agents, the two together in fact cross-link but do so dependent on their volume ratio. Composition 14 forms a very weak composite which is compared with composition 12 that showed very high strength. Most of the compositions that had 417 g of solution showed weak strength. However, borate ions do not need certain amounts of water to maintain their structure, unlike Xanthan and guar gum. Therefore, blending to polymers showed the same weaknesses as the high volumes of polymer solutions in the other polymers such as compositions for, seven and 10.

The guar gum and Xanthan combination forms trisaccharide branches of Xanthan gum that appear to be closely aligned with the polymer backbone. The resulting stiff chain may exist as a single, double or triple helix. These parts can interact with the other polymer molecules to form a complex. Guar gums are formed by a backbone chain of mannose units linked to a monomolecular unit of galactose. The relations between mannose and galactose, and the hair like distribution of galactose in the backbone, is typical of every galactomannan. The galactose residues are not uniformly distributed, in fact there are regions with many galactose residues, called hairy region, and other regions without galactose called smooth regions. Copolymer interaction between Xanthan and guar can possibly take place in the smooth regions, since these smooth regions provide attaching sites for the Xanthan molecules.

A mixture of Xanthan and guar gum can therefore provide the synergistic effect of connecting the Xanthan gum to unsubstituted mannose regions (smooth part) of the guar gum, and thereby bind the metal ion are the concrete lattice via a synergistic cross-link.

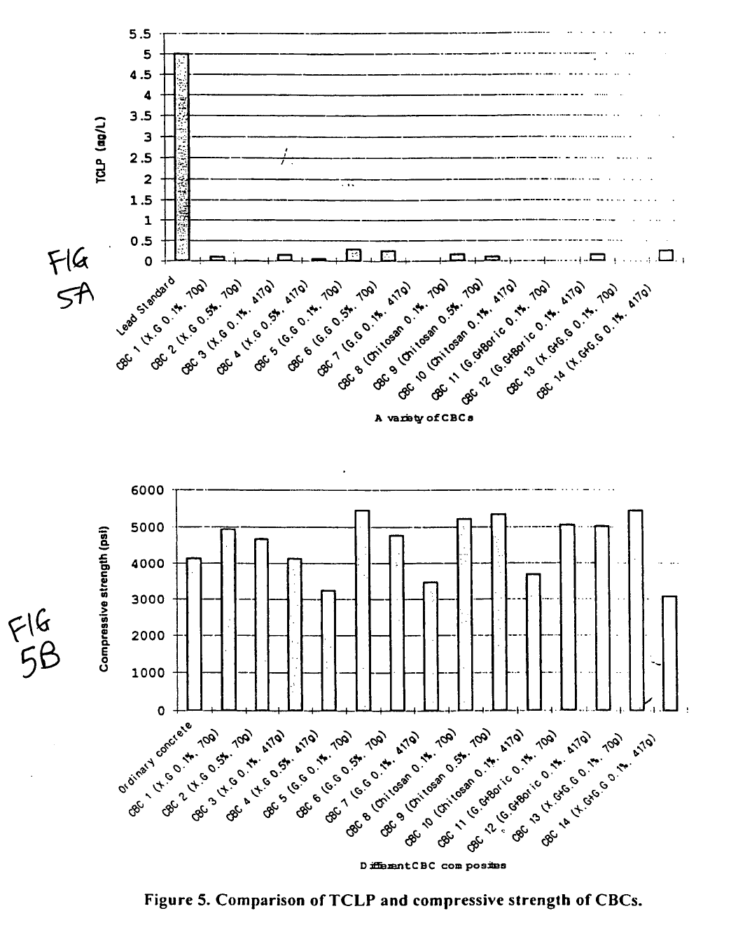

FIG. 5 illustrates the results of the products of the CBC components. Most of these composites are harmless to humans because of the low value of lead leaching. Compositions 7, 10, 11 and 13 have no lead leaching at all. Compositions 11 and 13 showed very high compressive strengths. Adding a biopolymer and cross-linked solution helps increase the strength of the excessive amounts of the polymer and cross-linked solution may decrease the strength of compression of the concrete. The water ratio is a key parameter in determining the strength. Adequate strength can not be obtained until the water is supplied sufficiently to provide fundamental structure, regardless of the biopolymer concentration. The biopolymer may form a hydrogel, which can absorb water as much as a thousand times the weight of the biopolymer. Therefore, viscosity does not increase the composite strength.

FIG. 6 illustrates how lead from the CRT waste can be bound inside the concrete structure. The composite is cross-linked by biopolymers or by a cross-linked solution. Functional groups are used for this cross-linked reaction to take place. Giant molecular polymers provide chemical sites for the lead to bind onto the concrete molecules. This microstructure may contain different sized pores, micro pores which are less than 2 nm, pores which are between 2 and 50 nm and macro pores which are greater than 50 nm. These may form a net to entrap the lead particles. FIG. 6 shows a biopolymer, or cross-linked solution, being placed between the lead and the concrete, thereby aiding the bridging reaction. Different functional groups and bindings owned by the Xanthan gum the guar gum and the Chitosan or cross-linked solution spread themselves along the backbone and side chains of the polymers in intraband intermolecular three-dimensional configurations. This cross-linked composite will become a Geo polymer, with the bounded metal being chemically and physically trapped and stabilized within the material.

In the CBC composites, the CRT glass may be used to replace sand. The addition of CRT glass may simply include 67% CaO (alite), 22 percent SiO₂, belite, 5% Al₂O₃, (aluminate), and 3% FeO₃, (ferrite) and other trace materials. CRT glass is very close to sand material in terms of its chemical structure. Also, the lead from the CRT and biopolymer have a high affinity for the carbonate system. A chelation between them enables a cross-linked reaction to occur in a concrete microstructure.

Although only a few embodiments have been disclosed in detail above, other modifications are possible, and this disclosure is intended to cover all such modifications, and most particularly, any modification which might be predictable to a person having ordinary skill in the art. For example, other biopolymers may be used in place of the specific materials described herein. In addition, different kinds of waste, other than CRT glass, may be encapsulated within the materials, using similar chemical techniques.

Also, only those claims which use the words “means for” are intended to be interpreted under 35 USC 112, sixth paragraph. Moreover, no limitations from the specification are intended to be read into any claims, unless those limitations are expressly included in the claims.

1. A method comprising:
forming a concrete material using CRT glass that includes lead as a component thereof in a way that stabilizes the CRT glass and prevents lead from leaching out of the glass by more than a specified amount.

2. A method as in claim 1, wherein said specified amount is less than 5 mg per liter of lead leachability.

3. A method as in claim 1, wherein said stabilizing comprises using a biopolymer to encapsulate lead within the CRT glass.

4. A method as in claim 3, wherein the biopolymer is Xanthan gum.

5. A method as in claim 3, wherein the biopolymer is guar gum.

6. A method as in claim 3, wherein the biopolymer is Chitosan.

7. A method as in claim 1, wherein said stabilizing comprises cross-linking within the concrete material.

8. A method as in claim 7, wherein said cross-linking uses a cross-linking agent.

9. A method as in claim 8, wherein said cross-linking agent is boric acid.

10. A method as in claim 3, wherein said stabilizing comprises cross-linking within the material.

11. A method as in claim 10, wherein said cross-linking uses a cross-linking agent.

12. A method as in claim 10, wherein said cross-linking uses a combination of said biopolymers to carry out cross-linking.

13. A structural material comprising:
A cement material;
A sand material, mixed with the cement,
A waste sand material, having a lead content, mixed with the cement; and
A binding agent, which binds said lead content, to prevent said lead content from leaching out of the structural material.

14. A structural material as in claim 13, wherein said specified amount is less than 5 mg per liter of lead leachability.

15. A structural material as in claim 13, wherein said binding agent includes a biopolymer that encapsulates lead within the waste sand material.

16. A structural material as in claim 15, wherein the biopolymer is Xanthan gum.

17. A structural material as in claim 15, wherein the biopolymer is guar gum.

18. A structural material as in claim 15, wherein the biopolymer is Chitosan.

19. A structural material as in claim 13, wherein said binding agent includes a material that causes cross-linking within the structural material.

20. A structural material as in claim 13, wherein said material has a compressive strength that is at least as great as a compressive strength of concrete.

21. A structural material as in claim 13, further comprising a water additive, comprising at least 38% of a water to concrete ration.

22. A structural material as in claim 19, wherein said cross-linking agent is boric acid.

23. A structural material as in claim 19, wherein said cross-linking uses a combination of said biopolymers to carry out cross-linking.

24. A method comprising:
using a biopolymer to encapsulate lead from CRT wastes.

25. A method as in claim 24, wherein the biopolymer is Xanthan gum.

26. A method as in claim 24, wherein the biopolymer is guar gum.

27. A method as in claim 24, wherein the biopolymer is Chitosan.

28. A method as in claim 24, further comprising cross-linking within the concrete material.
